(19) United States
(12) Patent Application Publication
(10) Pub. No.: US 2024/0059890 A1
(43) Pub. Date: Feb. 22, 2024

(54) Thermoplastic Resin Composition and Molded Product Manufactured Therefrom

(71) Applicant: LOTTE CHEMICAL CORPORATION, Seoul (KR)

(72) Inventors: Yeong Deuk SEO, Uiwang-si (KR); Min Soo LEE, Uiwang-si (KR); Ye Seul SHIN, Uiwang-si (KR); Bong Jae LEE, Uiwang-si (KR)

(21) Appl. No.: 18/269,614

(22) PCT Filed: Dec. 1, 2021
(86) PCT No.: PCT/KR2021/017998

§ 371 Date: Jun. 26, 2023

(30) Foreign Application Priority Data
Dec. 30, 2020 (KR) 10-2020-0187481

(51) Int. Cl. C08L 67/02; B32B 15/09; B32B 15/085; B32B 27/36; B32B 27/18; B32B 27/32

(52) U.S. Cl. CPC C08L 67/02; B32B 15/09; B32B 15/085; B32B 27/365; B32B 27/18; B32B 27/32; B32B 2270/00; B32B 2262/101; B32B 2307/748; B32B 2307/558; B32B 2307/546; B32B 2250/02

(57) ABSTRACT

A thermoplastic resin composition of the present invention comprises: approximately 100 parts by weight of a polyester resin; approximately 5-30 parts by weight of a polycarbonate resin; approximately 50-150 parts by weight of a flat glass fiber; approximately 2-10 parts by an epoxy-modified olefin-based copolymer; and approximately 2-10 parts by weight of a maleic anhydride-modified ethylene-propylene-diene monomer terpolymer, wherein the weight ratio of the epoxy-modified olefin-based copolymer and the maleic anhydride-modified ethylene-propylene-diene monomer terpolymer is approximately 1:0.5 to 1:2. The thermoplastic resin composition has excellent metal bonding property, impact resistance, stiffness, retention heat stability, balance of physical properties thereof, and the like.

### TECHNICAL FIELD

The present invention relates to a thermoplastic resin composition and a molded article produced therefrom. More particularly, the present invention relates to a thermoplastic resin composition that exhibits good properties in terms of metal adhesion, impact resistance, rigidity, retention heat stability, and balance therebetween, and a molded article produced therefrom.

### BACKGROUND ART

As engineering plastics, a polyester resin and a blend of a polyester resin and a polycarbonate resin exhibit useful properties and are applied to various fields comprising interior/exterior materials for electric/electronic products. However, the polyester resin has problems of low crystallization rate, low mechanical strength, and low impact strength.

Thus, various attempts have been made to improve mechanical properties comprising impact resistance and rigidity of the polyester resin by adding additives, such as inorganic fillers and the like, to the polyester resin. For example, polybutylene terephthalate (PBT) resins reinforced by inorganic fillers, such as glass fiber and the like, are used for automobile components or housings of mobile phones. However, such materials have a limitation in improvement in impact resistance, rigidity, retention heat stability, and the like, and cause deterioration in metal adhesion and the like.

Therefore, there is a need for a thermoplastic resin composition having good properties in terms of metal adhesion, impact resistance, rigidity, retention heat stability, and balance therebetween.

The background technique of the present invention is disclosed in Korean Patent Registration No. 10-0709878 and the like.

### DISCLOSURE

### Technical Problem

It is one aspect of the present invention to provide a thermoplastic resin composition that exhibits good properties in terms of metal adhesion, impact resistance, rigidity, retention heat stability, and balance therebetween.

It is another aspect of the present invention to provide a molded article formed from the thermoplastic resin composition.

The above and other aspects of the present invention can be achieved by the present invention described below.

### Technical Solution

1. One aspect of the present invention relates to a thermoplastic resin composition. The thermoplastic resin composition comprises: about 100 parts by weight of a polyester resin; about 5 to about 30 parts by weight of a polycarbonate resin; about 50 to about 150 parts by weight of a flat glass fiber; about 2 to about 10 parts by weight of an epoxy-modified olefin copolymer; and about 2 to about 10 parts by weight of a maleic anhydride-modified ethylene-propylene-diene monomer terpolymer, wherein the epoxy-modified olefin copolymer and the maleic anhydride-modified ethylene-propylene-diene monomer terpolymer are present in a weight ratio of about 1:0.5 to about 1:2.

2. In embodiment 1, the polyester resin may comprise at least one of polybutylene terephthalate, polyethylene terephthalate, and polycyclohexylenedimethylene terephthalate.

3. In embodiment 1 or 2, the flat glass fiber may have a rectangular cross-section with a curved corner, a cross-section aspect ratio (long-side length/short-side length in cross-section) of about 1.5 to about 10, and a short-side length of about 2 μm to about 10 μm in cross-section.

4. In embodiments 1 to 3, the epoxy-modified olefin copolymer may comprise at least one of a glycidyl (meth)acrylate-modified ethylene-butyl acrylate copolymer, a glycidyl (meth)acrylate-modified ethylene-methyl acrylate copolymer, and a glycidyl (meth)acrylate-modified ethylene-ethyl acrylate copolymer.

5. In embodiments 1 to 4, the thermoplastic resin composition may have a metal bonding strength of about 30 MPa to about 50 MPa, as measured with respect to an aluminum specimen in accordance with ISO 19095.

6. In embodiments 1 to 5, the thermoplastic resin composition may have a dart drop height of about 65 cm to about 100 cm, at which cracks are generated on a 2 mm thick specimen upon dropping a 500 g dart onto the specimen in accordance with a DuPont drop test method, and a notched Izod impact strength of about 10 kgf·cm/cm to about 25 kgf·cm/cm, as measured on a ⅛″ thick specimen in accordance with ASTM D256.

7. In embodiments 1 to 6, the thermoplastic resin composition may have a flexural modulus of about 90,000 kgf/cm² to about 140,000 kgf/cm², as measured on a ¼″ thick specimen at 2.8 mm/min in accordance with ASTM D790.

8. In embodiments 1 to 7, the thermoplastic resin composition may have a dart drop height of about 40 cm to about 70 cm, at which cracks are generated on a 2 mm thick injection-molded specimen upon dropping a 500 g dart onto the specimen in accordance with a DuPont drop test method after the specimen is left inside a cylinder of an injection molding machine at 280° C. for 2 min.

9. Another aspect of the present invention relates to a molded article. The molded article may be formed of the thermoplastic resin composition according to any one of embodiments 1 to 8.

10. A further aspect of the present invention relates to a composite material. The composite material comprises a plastic member produced from the molded article according to embodiment 9; and a metal member adjoining the plastic member.

11. In embodiment 10, the metal member may comprise at least one of aluminum, titanium, iron, and zinc.

12. In embodiment 10 or 11, the metal member may comprise aluminum, and the plastic member may have a metal bonding strength of about 30 MPa to about 50 MPa, as measured with respect to the metal member in accordance with ISO 19095, a dart drop height of about 65 cm to about 100 cm, at which cracks are generated on a 2 mm thick plastic member upon dropping a 500 g dart onto the specimen in accordance with a DuPont drop test method, a notched Izod impact strength of about 10 kgf·cm/cm to about 25 kgf·cm/cm, as measured on a ⅛″ thick specimen in accordance with ASTM D256, a flexural modulus of about 90,000 kgf/cm² to about 140,000 kgf/cm², as measured on a ¼″ thick specimen at 2.8 mm/min in accordance with ASTM D790, and a dart drop height of about 40 cm to about 70 cm, at which cracks are generated on a 2 mm thick injection-molded specimen (plastic member) upon dropping a 500 g dart onto the specimen in accordance with a DuPont drop test method after the specimen is left inside a cylinder of an injection molding machine at 280° C. for 2 min.

### Advantageous Effects

The present invention provides a thermoplastic resin composition that has good properties in terms of metal adhesion, impact resistance, rigidity, retention heat stability, and balance therebetween, and a molded article formed therefrom.

### BEST MODE

Hereinafter, embodiments of the present invention will be described in detail.

A thermoplastic resin composition according to the present invention comprises: (A) a polyester resin; (B) a polycarbonate resin; (C) a flat glass fiber; (D) an epoxy-modified olefin copolymer; and (E) a maleic anhydride-modified ethylene-propylene-diene monomer terpolymer.

As used herein to represent a specific numerical range, the expression “a to b” means “≥a and ≤b”.

(A) Polyester Resin

According to the present invention, the polyester resin may be selected from any polyester resins used in a typical thermoplastic resin composition. For example, the polyester resin may be obtained by polycondensation of a dicarboxylic acid component and a diol component, in which the dicarboxylic acid component may comprise: aromatic dicarboxylic acids, such as terephthalic acid (TPA), isophthalic acid (IPA), 1,2-naphthalene dicarboxylic acid, 1,4-naphthalene dicarboxylic acid, 1,5-naphthalene dicarboxylic acid, 1,6-naphthalene dicarboxylic acid, 1,7-naphthalene dicarboxylic acid, 1,8-naphthalene dicarboxylic acid, 2,3-naphthalene dicarboxylic acid, 2,6-naphthalene dicarboxylic acid, 2,7-naphthalene dicarboxylic acid, and the like; and aromatic dicarboxylates, such as dimethyl terephthalate (DMT), dimethyl isophthalate, dimethyl-1,2-naphthalate, dimethyl-1,5-naphthalate, dimethyl-1,7-naphthalate, dimethyl-1,7-naphthalate, dimethyl-1,8-naphthalate, dimethyl-2,3-naphthalate, dimethyl-2,6-naphthalate, dimethyl-2,7-naphthalate, and the like, and in which the diol component may comprise ethylene glycol, 1,2-propylene glycol, 1,3-propylene glycol, 2,2-dimethyl-1,3-propanediol, 1,3-butanediol, 1,4-butanediol, 1,5-pentanediol, 1,5-pentanediol, 1,6-hexanediol, and a cycloalkylene diol.

In some embodiments, the polyester resin may comprise at least one of polybutylene terephthalate (PBT), polyethylene terephthalate (PET), polyethylene naphthalate (PEN), polytrimethylene terephthalate (PTT), and polycyclohexylenedimethylene terephthalate (PCT). Preferably, the polyester resin comprises at least one of polybutylene terephthalate, polyethylene terephthalate, and polycyclohexylenedimethylene terephthalate.

In some embodiments, the polyester resin may have an inherent viscosity of about 0.5 dl/g to about 1.5 dl/g, for example, about 0.7 dl/g to about 1.4 dl/g, as measured in accordance with ASTM D2857. Within this range, the thermoplastic resin composition can exhibit good mechanical properties and the like.

(B) Polycarbonate Resin

According to the present invention, the polycarbonate resin serves to improve impact resistance and appearance characteristics of the thermoplastic resin composition and may comprise any polycarbonate resin used in typical thermoplastic resin compositions. For example, the polycarbonate resin may be an aromatic polycarbonate resin prepared by reacting diphenols (aromatic diol compounds) with a precursor, such as phosgene, halogen formate, or carbonate diester.

In some embodiments, the diphenols may comprise, for example, 4,4′-biphenol, 2,2-bis(4-hydroxyphenyl)propane, 2,4-bis(4-hydroxyphenyl)-2-methylbutane, 1,1-bis(4-hydroxyphenyl)cyclohexane, 2,2-bis(3-chloro-4-hydroxyphenyl)propane, 2,2-bis(3,5-dichloro-4-hydroxyphenyl)propane, 2,2-bis(3-methyl-4-hydroxyphenyl)propane, and 2,2-bis(3,5-dimethyl-4-hydroxyphenyl)propane, without being limited thereto. For example, the diphenols may be 2,2-bis(4-hydroxyphenyl)propane, 2,2-bis(3,5-dichloro-4-hydroxyphenyl)propane, 2,2-bis(3-methyl-4-hydroxyphenyl)propane, 2,2-bis(3,5-dimethyl-4-hydroxyphenyl)propane, or 1,1-bis(4-hydroxyphenyl)cyclohexane, specifically 2,2-bis(4-hydroxyphenyl)propane, which is also referred to as bisphenol-A.

In some embodiments, the polycarbonate resin may be a branched polycarbonate resin. For example, the polycarbonate resin may be a polycarbonate resin prepared by adding a tri- or higher polyfunctional compound, specifically, a tri- or higher valent phenol group-containing compound, in an amount of about 0.05 mol % to about 2 mol % based on the total number of moles of the diphenols used in polymerization.

In some embodiments, the polycarbonate resin may be a homopolycarbonate resin, a copolycarbonate resin, or a blend thereof. In addition, the polycarbonate resin may be partly or completely replaced by an aromatic polyester-carbonate resin obtained by polymerization in the presence of an ester precursor, for example, a bifunctional carboxylic acid.

In some embodiments, the polycarbonate resin may have a weight average molecular weight (Mw) of about 20,000 g/mol to about 50,000 g/mol, for example, about 25,000 g/mol to about 40,000 g/mol, as measured by gel permeation chromatography (GPC). Within this range, the thermoplastic resin composition can have good fluidity (processability).

In some embodiments, the polycarbonate resin may be present in an amount of about 5 to about 30 parts by weight, for example, about 10 to about 15 parts by weight, relative to about 100 parts by weight of the polyester resin. If the content of the polycarbonate resin is less than about 5 parts by weight relative to about 100 parts by weight of the polyester resin, the resin composition can suffer from deterioration in metal adhesion, impact resistance, retention heat stability, and the like, and if the content of the polycarbonate resin exceeds about 30 parts by weight, the resin composition can suffer from deterioration in metal adhesion, impact resistance, retention heat stability, and the like.

(C) Flat Glass Fiber

According to the present invention, the flat glass fiber serves to improve rigidity, impact resistance, and metal adhesion of the thermoplastic resin composition comprising the polyester resin and the polycarbonate resin together with the epoxy-modified olefin copolymer and the maleic anhydride-modified ethylene-propylene-diene monomer terpolymer.

In some embodiments, the flat glass fiber may have a rectangular cross-section, a rectangular cross-section with a curved corner, or an elliptical cross-section, and may have a cross-section aspect ratio (long-side length/short-side length in cross-section) of about 1.5 to about 10, a short-side length of about 2 μm to about 10 μm, and a pre-processing length of about 2 mm to about 20 mm. Within this range, the thermoplastic resin composition can have good properties in terms of rigidity, processability, and the like.

In some embodiments, the flat glass fiber may be subjected to surface treatment with a typical surface treatment agent. The surface treatment agent may comprise a silane compound, a urethane compound, an epoxy compound, and the like, without being limited thereto.

In some embodiments, the flat glass fiber may be present in an amount of about 50 to about 150 parts by weight, for example, about 70 to about 100 parts by weight, relative to about 100 parts by weight of the polyester resin. If the content of the flat glass fiber is less than about 50 parts by weight relative to about 100 parts by weight of the polyester resin, the resin composition can suffer from deterioration in rigidity, flexibility (warpage), and the like, and if the content of the flat glass fiber exceeds about 150 parts by weight, the resin composition can suffer from deterioration in metal adhesion, impact resistance, retention heat stability, appearance characteristics, and the like.

(D) Epoxy-Modified Olefin Copolymer

According to the present invention, the epoxy-modified olefin copolymer serves to improve metal adhesion, impact resistance, rigidity, and retention heat stability of the thermoplastic resin composition comprising the polyester resin and the polycarbonate resin together with the flat glass fiber and the maleic anhydride-modified ethylene-propylene-diene monomer terpolymer, and may be a reactive olefin copolymer prepared by adding an epoxy compound as a reactive functional group to an olefin copolymer for modification of the olefin copolymer.

In some embodiments, the epoxy compound may comprise glycidyl (meth)acrylate, allyl glycidyl ether, 2-methyl-allyl glycidyl ether, and mixtures thereof.

In some embodiments, the epoxy-modified olefin copolymer may be prepared through copolymerization of the epoxy compound with an olefin copolymer obtained through copolymerization of an alkylene monomer and an alkyl (meth)acrylate monomer. The alkylene monomer may be a C2 to C10 alkylene, for example, ethylene, propylene, isopropylene, butylene, isobutylene, octene, and combinations thereof. The alkyl (meth)acrylate monomer may be a C1 to C8 alkyl (meth)acrylate, for example, methyl acrylate, ethyl acrylate, n-propyl acrylate, n-butyl acrylate, 2-ethylhexyl acrylate, methyl methacrylate, ethyl methacrylate, n-propyl methacrylate, n-butyl methacrylate, 2-ethylhexyl methacrylate, and combinations thereof.

In some embodiments, the epoxy-modified olefin copolymer may comprise a glycidyl (meth)acrylate-modified ethylene-methyl acrylate copolymer, a glycidyl (meth)acrylate-modified ethylene-ethyl acrylate copolymer, a glycidyl (meth)acrylate-modified ethylene-butyl acrylate copolymer, and combinations thereof.

In some embodiments, the epoxy-modified olefin copolymer may have a melt-flow index of about 1 g/10 min to about 50 g/10 min, for example, about 2 g/10 min to about 25 g/10, as measured at 190° C. under a load of 2.16 kg in accordance with ASTM D1238. Within this range, the thermoplastic resin composition can exhibit good impact resistance.

In some embodiments, the epoxy-modified olefin copolymer may be present in an amount of about 2 to about 10 parts by weight, for example, about 3 to about 6 parts by weight, relative to about 100 parts by weight of the polyester resin. If the content of the epoxy-modified olefin copolymer is less than about 2 parts by weight relative to about 100 parts by weight of the polyester resin, the thermoplastic resin composition can suffer from deterioration in metal adhesion, rigidity, and the like, and if the content of the epoxy-modified olefin copolymer exceeds about 10 parts by weight, the thermoplastic resin composition can suffer from deterioration in metal adhesion and the like.

In some embodiments, the flat glass fiber (C) and the epoxy-modified olefin copolymer (D) may be present in a weight ratio (C:D) of about 1:0.02 to about 1:0.1, for example, about 1:0.03 to about 1:0.08. Within this range, the thermoplastic resin composition can exhibit further improved properties in terms of metal adhesion, retention heat stability, and the like.

(E) Maleic Anhydride-Modified Ethylene-Propylene-Diene Monomer Terpolymer

According to the present invention, the maleic anhydride-modified ethylene-propylene-diene monomer terpolymer serves to improve metal adhesion, impact resistance, rigidity, and retention heat stability of the thermoplastic resin composition comprising the polyester resin and the polycarbonate resin together with the flat glass fiber and the epoxy-modified olefin copolymer, and may be obtained through graft polymerization of maleic anhydride (MAH) to ethylene-propylene-diene monomer terpolymer (EPDM) rubber. For example, the ethylene-propylene-diene monomer terpolymer, to which the maleic anhydride is grafted, may be prepared using a twin screw extruder by a reaction extrusion method, in which peroxide is added to the ethylene-propylene-diene monomer terpolymer to break an ethylene bond and to generate a free radical so as to allow the maleic anhydride to be introduced into the ethylene bond.

In some embodiments, the maleic anhydride-modified ethylene-propylene-diene monomer terpolymer may have a melt flow index of about 1 g/10 min to about 10 g/10 min, for example, about 2 g/10 min to about 5 g/10 min, as measured at 230° C. under a load of 2.16 kg in accordance with ASTM D1238.

In some embodiments, the maleic anhydride-modified ethylene-propylene-diene monomer terpolymer may be present in an amount of about 2 to about 10 parts by weight, for example, about 3 to about 8 parts by weight, relative to about 100 parts by weight of the polyester resin. If the content of the maleic anhydride-modified ethylene-propylene-diene monomer terpolymer is less than about 2 parts by weight relative to about 100 parts by weight of the polyester resin, the resin composition can suffer from deterioration in impact resistance, retention heat stability, and the like, and if the content of the maleic anhydride-modified ethylene-propylene-diene monomer terpolymer exceeds about 10 parts by weight, the resin composition can suffer from deterioration in metal adhesion and the like.

In some embodiments, the epoxy-modified olefin copolymer (D) and the maleic anhydride-modified ethylene-propylene-diene monomer terpolymer (E) may be present in a weight ratio (D:E) of about 1:0.5 to about 1:2, for example, about 1:0.5 to about 1:1.8. If the weight ratio (D:E) is less than about 1:0.5, the resin composition can suffer from deterioration in metal adhesion, impact resistance, retention heat stability, and the like, and if the weight ratio (D:E) exceeds about 1:2, the resin composition can suffer from deterioration in metal adhesion and the like.

In some embodiments, the thermoplastic resin composition may further comprise additives for typical thermoplastic resin compositions. Examples of the additives may comprise an impact modifier, a flame retardant, an antioxidant, an anti-dripping agent, a lubricant, a release agent, a nucleating agent, an antistatic agent, a stabilizer, pigments, dyes, and mixtures thereof, without being limited thereto. The additives may be present in an amount of about 0.001 to about 40 parts by weight, for example, about 0.1 to about 10 parts by weight, relative to about 100 parts by weight of the polyester resin.

In some embodiments, the thermoplastic resin composition may be prepared in pellet form by mixing the aforementioned components, followed by melt extrusion at about 240° C. to about 300° C., for example, at about 250° C. to about 290° C., using a typical twin-screw extruder.

In some embodiments, the thermoplastic resin composition may have a metal bonding strength of about 30 MPa to about 50 MPa, for example, about 35 MPa to about 40 MPa, as measured with respect to an aluminum specimen in accordance with ISO 19095.

In some embodiments, the thermoplastic resin composition may have a dart drop height of about 65 cm to about 100 cm, for example, about 70 cm to about 99 cm, at which cracks are generated on a 2 mm thick specimen upon dropping a 500 g dart onto the specimen in accordance with a DuPont drop test method.

In some embodiments, the thermoplastic resin composition may have a notched Izod impact strength of about 10 kgf·cm/cm to about 25 kgf·cm/cm, for example, about 12 kgf·cm/cm to about 20 kgf·cm/cm, as measured on a ⅛″ thick specimen in accordance with ASTM D256.

In some embodiments, the thermoplastic resin composition may have a flexural modulus of about 90,000 kgf/cm² to about 140,000 kgf/cm², for example, about 95,000 kgf/cm² to about 135,000 kgf/cm², as measured on a ¼″ thick specimen at 2.8 mm/min in accordance with ASTM D790.

In some embodiments, the thermoplastic resin composition may have a dart drop height of about 40 cm to about 70 cm, for example, about 40 cm to about 60 cm, at which cracks are generated on a 2 mm thick injection-molded specimen upon dropping a 500 g dart onto the specimen in accordance with a DuPont drop test method after the specimen is left inside a cylinder of an injection molding machine at 280° C. for 2 min.

A molded article according to the present invention is produced from the thermoplastic resin composition as set forth above. The thermoplastic resin composition may be prepared in pellet form. The prepared pellets may be produced into various molded articles (products) by various molding methods, such as injection molding, extrusion molding, vacuum molding, casting, and the like. These molding methods are well known to those skilled in the art. The molded articles have good properties in terms of metal adhesion, impact resistance, rigidity, retention heat stability, and balance therebetween, and thus can be advantageously used for interior/exterior materials of electrical/electronic products, interior/exterior materials of automobiles, and the like.

A composition material according to the present invention may comprise a plastic member produced from the molded article; and a metal member adjoining the plastic member.

In some embodiments, the plastic member may directly adjoin the metal member without a bonding agent interposed therebetween. For example, the plastic member may be formed to directly adjoin the metal member by molding the plastic member on the metal member, which is subjected to surface treatment by an electrochemical method, through injection molding or the like.

In some embodiments, the metal member may comprise at least one of aluminum, titanium, iron, and zinc.

In some embodiments, the metal member comprises aluminum, and the plastic member may have a metal bonding strength of about 30 MPa to about 50 MPa, for example, about 35 MPa to about 40 MPa, as measured with respect to the metal member in accordance with ISO 19095; a dart drop height of about 65 cm to about 100 cm, for example, about 70 cm to about 99 cm, at which cracks are generated on a 2 mm thick plastic member upon dropping a 500 g dart onto the specimen in accordance with a DuPont drop test method; a notched Izod impact strength of about 10 kgf·cm/cm to about 25 kgf·cm/cm, for example, about 12 kgf·cm/cm to about 20 kgf·cm/cm, as measured on a ⅛″ thick specimen in accordance with ASTM D256; a flexural modulus of about 90,000 kgf/cm² to about 140,000 kgf/cm², for example, about 95,000 kgf/cm² to about 135,000 kgf/cm², as measured on a ¼ thick specimen at 2.8 mm/min in accordance with ASTM D790; and a dart drop height of about 40 cm to about 70 cm, for example, about 40 cm to about 60 cm, at which cracks are generated on a 2 mm thick injection-molded specimen upon dropping a 500 g dart onto the specimen in accordance with a DuPont drop test method after the specimen is left inside a cylinder of an injection molding machine at 280° C. for 2 min.

### MODE FOR INVENTION

Next, the present invention will be described in more detail with reference to some examples. It should be understood that these examples are provided for illustration only and are not to be construed in any way as limiting the invention.

### EXAMPLE

Details of components used in Examples and Comparative Examples are as follows.

(A) Polyester Resin

A polybutylene terephthalate (PBT) resin having an inherent viscosity of about 1.3 dl/g (Manufacturer: Shinkong Co., Ltd., Product Name: Shinite K006) was used.

(B) Polycarbonate Resin

A bisphenol-A polycarbonate resin having a weight average molecular weight of about 25,000 g/mol (Manufacturer: Lotte Chemical Co., Ltd.) was used.

(C) Flat Glass Fiber

Flat glass fibers having a short-side length of about 7 μm, a cross-section aspect ratio of about 4, and a pre-processing length of about 3 mm (Manufacturer: Nittobo Co., Ltd., Product Name: CSG 3PA-820) were used.

(D) Olefin Copolymer

A glycidyl methacrylate-modified ethylene-methyl acrylate copolymer (Manufacturer: Sumitomo Chemical Co., Ltd., Product Name: Igetabond BF-7M) was used.

(E) Maleic anhydride-modified ethylene-propylene-diene monomer terpolymer

(E1) A maleic anhydride-modified ethylene-propylene-diene monomer terpolymer (Manufacturer: ExxonMobil Co., Ltd., Product Name: Exxelor VA 1803) was used.

(E2) A maleic anhydride-modified ethylene-butene copolymer (Manufacturer: Mitsui Chemicals Co., Ltd., Product Name: Tafmer MH7020) was used.

### Examples 1 to 9 and Comparative Examples 1 to 11

The above components were mixed in amounts as listed in Tables 1 to 4 and subjected to extrusion under conditions of 260° C., thereby preparing a thermoplastic resin composition in pellet form. Extrusion was performed using a twin-screw extruder (L/D=44, Φ: 45 mm) and the prepared pellets were dried at 100° C. for 4 hours or more and injection-molded in a 6 oz. injection molding machine (molding temperature: 270° C., mold temperature: 120° C.), thereby preparing specimens. The prepared specimens were evaluated as to the following properties by the following method, and results are shown in Tables 1 to 4.

Property Measurement

(1) Metal bonding strength (unit: MPa): A specimen was prepared by bonding an aluminum specimen to a specimen of a thermoplastic resin composition through insert-injection molding of the resin composition into a mold with the metal specimen placed inside the mold, and bonding strength was measured in accordance with ISO 19095. Here, the metal specimen was subjected to TRI surface treatment (Geo Nation Co., Ltd.) to facilitate bonding to the specimen. The metal specimen and the thermoplastic resin composition specimen had a size of 1.2 cm×4 cm×0.3 cm and bonding strength was measured in a state that both specimens were bonded to each other through a bonding area of 1.2 cm×0.3 cm in cross-section.

(2) Sheet impact strength (unit: cm): A dart drop height, at which cracks were generated on a 2 mm thick plastic member upon dropping a 500 g dart onto the specimen in accordance with a DuPont drop test method, was measured.

(3) Notched Izod impact resistance (unit: kgf·cm/cm): Notched Izod impact strength was measured on a ⅛″ thick specimen in accordance with ASTM D256.

(4) Sheet impact strength after retention (unit: cm): A 2 mm thick specimen was prepared from pellets of a thermoplastic resin composition after the pellets were left inside a cylinder of an injection molding machine at 280° C. for 2 min, and retention heat stability was evaluated by measuring a dart drop height, at which cracks were generated on the specimen, using a 500 g dart in accordance with a DuPont drop method.

(5) Flexural modulus (unit: kgf/cm²): Flexural modulus was measured on a ¼″ thick specimen at 2.8 mm/min in accordance with ASTM D790.

TABLE 1

| | Example | | | | |
|---|---|---|---|---|---|
| | 1 | 2 | 3 | 4 | 5 |
| (A) (parts by weight) | 100 | 100 | 100 | 100 | 100 |
| (B) (parts by weight) | 10 | 13.7 | 15 | 13.7 | 13.7 |
| (C) (parts by weight) | 82.4 | 82.4 | 82.4 | 70 | 100 |
| (D) (parts by weight) | 5.3 | 5.3 | 5.3 | 5.3 | 5.3 |
| (E1) (parts by weight) | 5.3 | 5.3 | 5.3 | 5.3 | 5.3 |
| (E2) (parts by weight) | — | — | — | — | — |
| Metal bonding strength (MPa) | 36.6 | 37.8 | 38.9 | 37.5 | 35.0 |
| Sheet impact strength (cm) | 85 | 89 | 91 | 88 | 70 |
| Notched Izod impact strength | 15.4 | 15.9 | 15.0 | 16.0 | 12.4 |
| (kgf · cm/cm) | | | | | |
| Sheet impact strength after | 41 | 47 | 52 | 51 | 40 |
| retention (cm) | | | | | |
| Flexural modulus (kgf/cm²) | 110,000 | 110,000 | 110,000 | 98,000 | 133,000 |

TABLE 2

| | Example | | | |
|---|---|---|---|---|
| | 6 | 7 | 8 | 9 |
| (A) (parts by weight) | 100 | 100 | 100 | 100 |
| (B) (parts by weight) | 13.7 | 13.7 | 13.7 | 13.7 |
| (C) (parts by weight) | 82.4 | 82.4 | 82.4 | 82.4 |
| (D) (parts by weight) | 3 | 6 | 5.3 | 5.3 |
| (E1) (parts by weight) | 5.3 | 5.3 | 3 | 8 |
| (E2) (parts by weight) | — | — | — | — |
| Metal bonding | 37.8 | 35.7 | 38.1 | 39.3 |
| strength (MPa) | | | | |
| Sheet impact | 72 | 99 | 88 | 96 |
| strength (cm) | | | | |
| Notched Izod impact | 12.5 | 16.2 | 15.2 | 17.0 |
| strength (kgf · cm/cm) | | | | |
| Sheet impact strength | 41 | 52 | 49 | 58 |
| after retention (cm) | | | | |
| Flexural | 105,000 | 110,000 | 110,000 | 109,000 |
| modulus (kgf/cm²) | | | | |

TABLE 3

| | Comparative Example | | | | | |
|---|---|---|---|---|---|---|
| | 1 | 2 | 3 | 4 | 5 | 6 |
| (A) (parts by weight) | 100 | 100 | 100 | 100 | 100 | 100 |
| (B) (parts by weight) | 1 | 35 | 13.7 | 13.7 | 13.7 | 13.7 |
| (C) (parts by weight) | 82.4 | 82.4 | 45 | 155 | 82.4 | 82.4 |
| (D) (parts by weight) | 5.3 | 5.3 | 5.3 | 5.3 | 1 | 15 |
| (E1) (parts by weight) | 5.3 | 5.3 | 5.3 | 5.3 | 5.3 | 5.3 |
| (E2) (parts by weight) | — | — | — | — | — | — |
| Metal bonding strength (MPa) | 25.1 | 18.1 | 33.2 | 10.1 | 21.7 | 18.4 |
| Sheet impact strength (cm) | 61 | 53 | 83 | 15 | 99 | 98 |
| Notched Izod impact strength | 14.2 | 15.5 | 18.1 | 7.9 | 16.6 | 20.6 |
| (kgf · cm/cm) | | | | | | |
| Sheet impact strength after | 32 | 17 | 40 | 16 | 46 | 42 |
| retention (cm) | | | | | | |
| Flexural modulus (kgf/cm²) | 111,000 | 109,000 | 50,000 | 158,000 | 89,000 | 102,000 |

TABLE 4

| | Comparative Example | | | | |
|---|---|---|---|---|---|
| | 7 | 8 | 9 | 10 | 11 |
| (A) (parts by weight) | 100 | 100 | 100 | 100 | 100 |
| (B) (parts by weight) | 13.7 | 13.7 | 13.7 | 13.7 | 13.7 |
| (C) (parts by weight) | 82.4 | 82.4 | 82.4 | 82.4 | 82.4 |
| (D) (parts by weight) | 5.3 | 5.3 | 5.3 | 5 | 4 |
| (E1) (parts by weight) | 1 | 15 | — | 2 | 10 |
| (E2) (parts by weight) | — | — | 5.3 | — | — |
| Metal bonding strength (MPa) | 34.5 | 28.9 | 22.2 | 29.4 | 26.3 |
| Sheet impact strength (cm) | 55 | 92 | 51 | 58 | 99 |
| Notched Izod impact strength | 11.8 | 16.5 | 13.3 | 13.2 | 18 |
| (kgf · cm/cm) | | | | | |
| Sheet impact strength after | 26 | 46 | 23 | 40 | 54 |
| retention (cm) | | | | | |
| Flexural modulus (kgf/cm²) | 116,000 | 104,000 | 110,000 | 110,000 | 109,000 |

From the result, it could be seen that the thermoplastic resin compositions according to the present invention had good properties in terms of metal adhesion, impact resistance, rigidity, retention heat stability, and balance therebetween.

Conversely, it could be seen that the resin composition of Comparative Example 1 comprising an insufficient amount of the polycarbonate resin suffered from deterioration in metal adhesion, impact resistance (sheet impact strength), and the like; the resin composition of Comparative Example 2 comprising an excess of the polycarbonate resin suffered from deterioration in metal adhesion, impact resistance (sheet impact strength), retention heat stability, and the like; the resin composition of Comparative Example 3 comprising an insufficient amount of the flat glass fiber suffered from deterioration in rigidity and the like; and the resin composition of Comparative Example 4 comprising an excess of the flat glass fiber suffered from deterioration in metal adhesion, impact resistance (sheet impact strength, notched Izod impact strength), retention heat stability, and the like. It could be seen that the resin composition of Comparative Example 5 comprising an insufficient amount of the epoxy-modified olefin copolymer suffered from deterioration in metal adhesion, rigidity, and the like; the resin composition of Comparative Example 6 comprising an excess of the epoxy-modified olefin copolymer suffered from deterioration in metal adhesion and the like; the resin composition of Comparative Example 7 comprising an insufficient amount of the maleic anhydride-modified ethylene-propylene-diene monomer terpolymer suffered from deterioration in impact resistance (sheet impact strength), retention heat stability, and the like; the resin composition of Comparative Example 8 comprising an excess of the maleic anhydride-modified ethylene-propylene-diene monomer terpolymer suffered from deterioration in metal adhesion and the like; and the resin composition of Comparative Example 9 comprising the maleic anhydride-modified ethylene-butene copolymer (E2) instead of the maleic anhydride-modified ethylene-propylene-diene monomer terpolymer according to the present invention suffered from deterioration in metal adhesion, impact resistance (sheet impact strength), retention heat stability, and the like.

Further, it could be seen that, even with the epoxy-modified olefin copolymer and the maleic anhydride-modified ethylene-propylene-diene monomer terpolymer, the thermoplastic resin composition having a weight ratio (D:E) of less than about 1:0.5 (a weight ratio of 1:0.4) (Comparative Example 10) suffered from deterioration in metal adhesion, impact resistance (sheet impact strength), retention heat stability, and the like, and the thermoplastic resin composition having a weight ratio (D:E) of greater than about 1:2 (a weight ratio of 1:2.5) (Comparative Example 11) suffered from deterioration in metal adhesion and the like.

Although the present invention has been described with reference to some example embodiments, it should be understood by those skilled in the art that these embodiments are given by way of illustration only, and that various modifications, variations and alterations can be made without departing from the spirit and scope of the invention. Therefore, the embodiments should not be construed as limiting the technical spirit of the present invention, but should be construed as illustrating the technical spirit of the present invention. The scope of the invention should be interpreted according to the following appended claims as covering all modifications or variations derived from the appended claims and equivalents thereto.

1. A thermoplastic resin composition comprising:
about 100 parts by weight of a polyester resin;
about 5 to about 30 parts by weight of a polycarbonate resin;
about 50 to about 150 parts by weight of a flat glass fiber;
about 2 to about 10 parts by weight of an epoxy-modified olefin copolymer; and
about 2 to about 10 parts by weight of a maleic anhydride-modified ethylene-propylene-diene monomer terpolymer,
wherein the epoxy-modified olefin copolymer and the maleic anhydride-modified ethylene-propylene-diene monomer terpolymer are present in a weight ratio of about 1:0.5 to about 1:2.

2. The thermoplastic resin composition according to claim 1, wherein the polyester resin comprises at least one of polybutylene terephthalate, polyethylene terephthalate, and polycyclohexylenedimethylene terephthalate.

3. The thermoplastic resin composition according to claim 1, wherein the flat glass fiber has a rectangular cross-section with a curved corner, a cross-section aspect ratio (long-side length/short-side length in cross-section) of about 1.5 to about 10, and a short-side length of about 2 μm to about 10 μm in cross-section.

4. The thermoplastic resin composition according to claim 1, wherein the epoxy-modified olefin copolymer comprises at least one of a glycidyl (meth)acrylate-modified ethylene-methyl acrylate copolymer, a glycidyl (meth)acrylate-modified ethylene-ethyl acrylate copolymer, and a glycidyl (meth)acrylate-modified ethylene-butyl acrylate copolymer.

5. The thermoplastic resin composition according to claim 1, wherein the thermoplastic resin composition has a metal bonding strength of about 30 MPa to about 50 MPa, as measured with respect to an aluminum specimen in accordance with ISO 19095.

6. The thermoplastic resin composition according to claim 1, wherein the thermoplastic resin composition has a dart drop height of about 65 cm to about 100 cm, at which cracks are generated on a 2 mm thick specimen upon dropping a 500 g dart onto the specimen in accordance with a DuPont drop test method, and a notched Izod impact strength of about 10 kgf·cm/cm to about 25 kgf·cm/cm, as measured on a ⅛″ thick specimen in accordance with ASTM D256.

7. The thermoplastic resin composition according to claim 1, wherein the thermoplastic resin composition has a flexural modulus of about 90,000 kgf/cm² to about 140,000 kgf/cm², as measured on a ¼″ thick specimen at 2.8 mm/min in accordance with ASTM D790.

8. The thermoplastic resin composition according to claim 1, wherein the thermoplastic resin composition has a dart drop height of about 40 cm to about 70 cm, at which cracks are generated on a 2 mm thick injection-molded specimen upon dropping a 500 g dart onto the specimen in accordance with a DuPont drop test method after the specimen is left inside a cylinder of an injection molding machine at 280° C. for 2 min.

9. A molded article formed of the thermoplastic resin composition according to claim 1.

10. A composite material comprising:
a plastic member formed of the thermoplastic resin composition according to claim 1; and
a metal member adjoining the plastic member.

11. The composite material according to claim 10, wherein the metal member comprises at least one of aluminum, titanium, iron, and zinc.

12. The composite material according to claim 10, wherein the metal member comprises aluminum, and the plastic member has a metal bonding strength of about 30 MPa to about 50 MPa, as measured with respect to the metal member in accordance with ISO 19095, a dart drop height of about 65 cm to about 100 cm, at which cracks are generated on a 2 mm thick plastic member upon dropping a 500 g dart onto the specimen in accordance with a DuPont drop test method, a notched Izod impact strength of about 10 kgf·cm/cm to about 25 kgf·cm/cm, as measured on a ⅛″ thick specimen in accordance with ASTM D256, a flexural modulus of about 90,000 kgf/cm² to about 140,000 kgf/cm², as measured on a ¼″ thick specimen at 2.8 mm/min in accordance with ASTM D790, and a dart drop height of about 40 cm to about 70 cm, at which cracks are generated on a 2 mm thick injection-molded specimen (plastic member) upon dropping a 500 g dart onto the specimen in accordance with a DuPont drop test method after the specimen is left inside a cylinder of an injection molding machine at 280° C. for 2 min.
